(19) United States
(12) Patent Application Publication
(10) Pub. No.: US 2003/0066603 A1
(43) Pub. Date: Apr. 10, 2003

(54) Adhesive composition for bonding an elastomer to a substrate and a method for the bonding thereof

(75) Inventors: James R. Halladay, Harborcreek, PA (US); Hoa Quach, Erie, PA (US); Douglas H. Mowrey, Titusville, PA (US)

Correspondence Address: Lord Corporation, 111 Lord Drive, PO Box 8012, Cary, NC, 27512-8012, US

(73) Assignee: Lord Corporation

(21) Appl. No.: 09/933,328

(22) Filed: Aug. 20, 2001

(51) Int. Cl. B32B 7/12

(52) U.S. Cl. 156/329; 428/447; 156/331.2; 428/422.8; 428/343

(57) ABSTRACT

An adhesive composition useful for bonding silicone and other peroxide-cured elastomers is disclosed. The adhesive comprises a solvent, a crosslinker and a film former reactive with the elastomer for bonding the elastomer to a substrate. Preferably, the crosslinker is at least one organic compound having at least two maleimide groups, and the film former is a block copolymer with a polysilicone segment and a hard segment. A method of bonding an elastomer to a substrate, a composite and an article of manufacture are also disclosed.

### FIELD OF THE INVENTION

The present invention relates to a composition for bonding an elastomer to a substrate, in particular a metal substrate. More specifically, the present invention relates to an adhesive composition comprising a crosslinker and a film former. Preferably, the crosslinker comprises at least one organic compounds having at least two maleimide groups. Preferably, the film former is a block copolymer with a polysilicone segment. The present invention also relates to a method of bonding an elastomer to a substrate and an article of manufacture.

### BACKGROUND OF THE INVENTION

Adhesive compositions are used extensively in bonding natural and synthetic elastomers to themselves, and to other substrates such as metal, ceramic, glass and textiles to form laminates and bonded articles. Many of these adhesive compositions are solvent based. There is a need in industry for adhesive compositions with the capability to bond such materials. Attempts have been made to fill this need; however, often the resulting adhesive compositions are unsatisfactory.

Certain adhesive compositions are only suitable for bonding particular elastomers to particular substrates. Furthermore, over time many of these adhesive compositions have become less desirable. For example, specialty elastomers have been developed such as silicone, fluorocarbon and polyester elastomers. In particular, such specialty elastomers are specifically suited to certain applications because of their unusual characteristics, such as high heat resistance or chemical resistance. Existing adhesive compositions are often very unsuitable for use with such elastomers.

Furthermore, prior adhesive compositions almost always require one or more of a dinitroso compound, an oxime compound, a polyisocyanate compound, and an oxidizing agent. The high toxicity of these ingredients poses serious handling and safety problems, and the dinitroso compounds (e.g. poly-C nitroso), particularly poly(p-dinitrosobenzene poly DNB or p-dinitrosobenzene (DNB), exhibit fuming at relatively high cure temperatures. DNB is not seen to bond silicone elastomers, and inhibits the ability of silicone to crosslink or cure.

For example, U.S. Pat. No. 3,258,388, discusses the incorporation of poly-C-nitroso aromatic compounds into conventional rubber-to-metal adhesives to improve bonding. The conventional adhesives into which these compounds may be incorporated include compositions containing thermo-setting condensation polymers; polymers and copolymers of polar, ethylenically unsaturated materials; halogenated rubbers; and polyisocyanates.

U.S. Pat. No. 3,282,883 discloses an adhesive composition that includes dinitrosobenzene, chlorosulphonated polyethylene, and an orthoalkoxy aryl diisocyanate. This composition is produced by dissolving and/or dispersing the components in an organic solvent. The composition is for bonding natural and synthetic rubbers, such as ethylene-propylene-nonconjugated diene terpolymers, neoprene, styrene-butadiene rubber, butyl rubber, halobutyl rubber, butadiene-acrylonitrile, halosulfonated polyethylene rubber, polyurethane rubber, and polyacrylate rubber. The rubbers may be bonded to themselves or to other substrates, such as metals.

U.S. Pat. No. 3,824,217 discloses combining an oxime compound with an excess of a polyisocyanate compound, so that all oxime groups are reacted with isocyanate. The resulting compound may be used in compositions for bonding rubbers to primed metal substrates.

U.S. Pat. No. 3,830,784 discloses an adhesive composition that includes a poly-C-nitroso aromatic compound, a polyisocyanate that is reactive at room temperature or greater, and an acidic halogen-containing polymer. The composition is produced by dissolving the acidic halogen-containing polymer and the aromatic polyisocyanate in an organic solvent, and the poly-c-nitroso aromatic compound is dispersed in the resulting solution. The resultant composition is shelf-stable and forms a strong adhesive bond between the substrate and the elastomer during vulcanization thereof.

U.S. Pat. No. 4,581,092 discloses a cold-vulcanizable adhesive system for bonding vulcanized rubbers. The system is of particular use in creating durable seams between rubber strips or sheets. The adhesive compositions include butyl rubber, a polyisocyanate compound, and at least one of a nitroso compound and an oxime compound, with the oxime compound requiring the additional presence of an oxidizing agent.

U.S. Pat. No. 6,132,870 discloses a reinforced composite including an elastomer of low unsaturation, a reinforcing fiber, an adhesive composition that bonds the elastomer to the coated reinforcing fiber including a halogenated polyolefin, a nitroso compound, a maleimide, the maleimide present in an amount of at least 50% by weight of the halogenated polyolefin.

Thus, there still remains a need for new adhesive compositions that are simple, safe, stable, and effective for bonding specialty elastomers to substrates, particularly metal substrates.

### SUMMARY OF THE INVENTION

The present invention provides adhesive compositions that bond silicone elastomers or other peroxide cured (vulcanized) elastomers to substrates. In particular, the invention is directed to an adhesive composition that comprises a solvent, crosslinker and a film former. In one aspect of the present invention, the crosslinker is at least one organic compound having at least two maleimide groups, and the film former is a block copolymer containing a polysilicone (polysiloxane) segment and a hard segment.

The present invention is further directed to a method of bonding an a curable elastomer to a substrate comprising coating the substrate with an adhesive composition comprising at least one organic crosslinker compound reactive with the elastomer in the presence of a peroxide cure system and a film former that is a block copolymer with a polysilicone segment, drying the adhesive composition coating, applying the elastomer to the adhesive composition coating, and curing the elastomer with heat.

The present invention is also directed to an article of manufacture comprising a metal substrate; an adhesive composition comprising at least one organic crosslinker compound and a film former that is a block copolymer with a polysilicone segment; and an elastomer, wherein the elastomer is bonded with the adhesive composition. Preferably, the elastomer is a peroxide cured silicone or hydrogenated nitrile butadiene rubber (HNBR).

### DETAILED DESCRIPTION OF THE INVENTION

The adhesive compositions of the present invention have been found to have superior bonding characteristics when bonding peroxide cured elastomers. These elastomers are known to be difficult to bond to substrates, especially metal substrates. Surprisingly, it has been discovered that the adhesive compositions of the present invention also provide excellent adhesion for other types of peroxide cured elastomeric materials.

The preferred adhesive compositions of the present invention comprise as a crosslinker an organic compound having at least two maleimide groups and a film former that is a block copolymer containing a polysiloxane segment.

The adhesive compositions of the present invention require a polyfunctional, free radical curable bonding agent as a crosslinker. The term “crosslinker” as used herein refers to a bonding agent that chemically couples the adhesive composition to itself, and to the substrate elastomer. Examples of suitable crosslinkers reactive with elastomer using peroxide cure systems and which are readily available include, but are not limited to, triallyl cyanurate, trimetharyl isocyanurate, triallyl isocyanurate, triacrylformal, triallyl trimellitate, bismaleimide, N,N′-m-phenylenebismaleimide, diallyl phthalate, tetrallyl terephthalamide, tris(diallylamine)-S-triazine, triallyl phosphite, and N,N-diallylacrylamide, metallic di- and triacrylates, such as zinc diacrylate, zinc triacrylate and zinc dimethacrylate. For example, the polyfunctional, free radical curable bonding agent used as a crosslinker in the present invention may be any known polyfunctional co-crosslinking agent which will react in the presence of a peroxide such as an organic peroxide in the case of a peroxide-curing elastomer.

Preferably the crosslinkers used in the adhesive compositions of present invention are one or more one organic compounds having at least two maleimide groups in one molecule. Maleimides suitable for use in the present invention include, but are not limited to, all of the maleimide, bismaleimide and related compounds that are described in U.S. Pat. Nos. 2,444,536 and 2,462,835, herein incorporated by reference. Preferred maleimide compounds include those formed conventionally by a condensation of maleic anhydride and a diamine compound which has a double bond originating from maleic anhydride at each terminus. A preferred bismaleimide resin employable in the present invention is a reaction product of two moles of maleic anhydride and one mole of an aromatic diamine. Examples of the aromatic diamine employable for this purpose include, but are not limited to, diaminobenzene, 4,4′-diamino-3,3′-dimethylbiphenyl, 1,4-diaminodiphenyl ether, 1,4-diaminodiphenylmethane, 2,2-bis(4-aminophenyl)propane, 1,4-diaminodiphenylsulfone, 1,3-bis(4-aminophenoxy)benzene, 1,4-bis(3-aminophenoxy)benzene, and bis(4-(3-aminophenoxy)phenyl)sulfone.

The N, N′-linked bismaleimides include two maleimide groups, which are either joined directly at the nitrogen atoms without any intervening structure or in which the nitrogen atoms are joined to and separated by an intervening divalent radical such as alkylene, cycloalkylene, oxydimethylene, phenylene (all 3 isomers), 2,6-dimethylene-4-alkyphenol, or sulfonyl. M-phenylene-bis-maleimide is a presently preferred compound, and is available as “HVA-2” from E. I. du Pont de Nemours and Co., (Inc.). Other commercially available bismaleimide resins are “Bismaleimide” of Mitui Toatsu Chemical Co., Ltd., “Bismaleimide (ATU-BMI resin) of Ajinomoto Co., Ltd., “Kelimide(NE20200)” of Nippon Polyimide Co., Ltd., and “Compimide 353” of Technochemie Co., Ltd.

Instead of a maleimide compound as defined above, the present invention may utilize a polymaleimide compound. The polymaleimide compound of the present invention may be an aliphatic or aromatic polymaleimide and must contain at least two maleimide groups. Aromatic polymaleimides having from about 1 to 100 aromatic nuclei wherein the maleimide groups are directly attached to each adjacent aromatic ring are preferred. An exemplary polymaleimide compound has the formula:

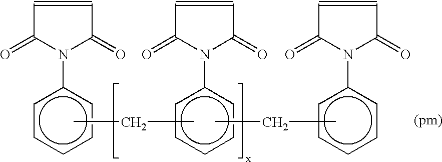

wherein x is from about 1 to 100. Such polymaleimides are commercially available globally under different trade names from different companies. A preferred polymaleimide is poly(bis)maleimide such as BMI-M-20 is supplied by Mitsui Toatsu Fine Chemicals Incorporated.

The crosslinker may be used in an amount from about 100 to about 2000 “parts by weight per 100 parts of the film former” (“phr”), preferably the crosslinker is present in an amount from about 400 to about 1000 parts by weight per 100 parts of the film former, and most preferably from 500 to 900 phr of film former.

The term “film former” as used herein refers to a substance that will form a film and which wets out a substrate surface to form a continuous skin when solvent is removed after drying. Typically the film former is soluble in the solvent and used in an amount of from about 2 to about 20 parts by weight per 100 weight parts of solvent. The film former acts as a binder for the crosslinking agent(s). Preferably, the film former is a block copolymer comprising a polysiloxane segment and a hard segment. Silicone block copolymers were found to be unexpectedly superior for bonding silicone elastomers and peroxide cured organic elastomers such as HNBR and they are the most preferred film formers used herein. Silicone polyimide block copolymers have known utility as encapsulants to protect against corrosion of highly reactive metal electrodes (e.g. calcium, magnesium, lithium) in organic electroluminescent light emitting devices. Examples of polyimide-siloxane block copolymers are disclosed in U.S. Pat. Nos. 5,213,864, 5,260,398, and 5,300,591, 5,739,263 and EP 598911 B 1. Commercially available silicone polyimide copolymers are sold under the KJR Series from Shin-Etsu Chemical Co., Ltd., Tokyo, JP. Siloxane-polyetherimide copolymers are commercially available under the SILTEM mark of GE Plastics, Pittsfield, Mass.; and under the SUMIRESIN mark of Sumitomo Bakelite Co., Ltd., Tokyo, Japan.

Also suitable for use as film formers in the present invention are poly(aryl-imide)-poly(dimethylsiloxane) copolymers. Exemplary preparation from a, ω-aminopropyl poly(dimethyl siloxane), bis(3-amino-phenoxy-4′-phenyl)phenylphosphine oxide and oxydiphthalic anhydride is disclosed in Synthesis And Characterization Of Triphenylphosphine Oxide-Containing Poly(Aryl Imide)—Poly(Dimethyl Siloxane) Randomly Segmented Copolymers, by Wescott, J. M., Tae Ho Yoon, Rodrigues, D., Kiefer, L. A., Wilkes, G. L., and Mcgrath, J. E., in the Journal of Macromolecular Science, Pure and Applied Chemistry, 1994, 31 (8) 1071-1085.

Aromatic polyamide-disiloxane multiblock copolymers are commercially available and also suitable for use as film formers in the present invention. An exemplary preparation from 1,3-bis(3-aminopropyl)-1,1,3,3-tetramethyldisiloxane and the aramid formed from 3,4′-diaminodiphenyl ether and isophthaloyl chloride is disclosed in Novel Functional Polymers: Poly(Dimethylsiloxane)—Polyamide Multiblock Copolymer. III. Synthesis And Surface Properties Of Disiloxane-Aromatic Polyamide Multiblock Copolymer, by Furuzono, T., Seki, K., Kishida, A., Ohshige, T., Waki, K., Maruyama, I., and Akashi, M., in The Journal of Applied Polymer Science; 59, No.7, Feb.14, 1996, p. 1059-65.

Other block copolymers having a polysilicone segment that are suitable for use in the present invention include, but are not limited to, poly(dimethylsiloxane)-etherimide copolymer commercially available from suppliers such as United Chemical Technologies, Inc., and silicone-polyetherimide block copolymer (Tosca Reg. No. 0.99904-16-2) commercially available from Gelest Inc.

If desirable, the adhesive compositions of the present invention may further comprise additives that include, but are not limited to, plasticizers, pigments, inert filler material, reinforcement fillers, carbon black, silica or silanes, with the amounts of such additions being within the ranges customarily employed. The additives may be used, for example, to further modify and improve the adhesive compositions.

The adhesive compositions of the present invention, however, comprise either no nitroso compound, such as dinitrosobenzene (DNB) or are essentially absent a nitroso compound such as dinitrosobenzene (DNB). “Essentially absent” in this context is defined as present in less than the amount which would form porosity in the cured rubber near the adhesive bond interface. The reason for this is that the presence of DNB at greater quantities has a gassing side effect that creates porosity.

The adhesive compositions of the present invention have been found to be particularly suitable for bonding a wide variety of elastomeric materials, including both vulcanized and vulcanizable elastomeric materials, to themselves or to other substrates, particularly to metal substrates. In one embodiment the adhesives bond peroxide cured silicone elastomers. These silicone elastomers are employed for long term performance at high temperatures. Peroxide cured silicone elastomers are more prevalent but are distinguished from addition cured, or condensation cured grades. Elastomers which can be bonded in accordance with the invention include but are not limited to, nitrile rubber, ethylene/propylene copolymer rubber (EPM); ethylene/propylene/diene terpolymer rubber (EPDM); peroxide cured hydrogenated nitrile butadiene rubbers (HNBR and ZSC HNBR) and the like. Other suitable elastomers include heat-curable elastomeric organosilicon polymers, that is, organopolysiloxanes, which, upon heating in combination with an appropriate curing agent, are converted to the solid, elastic state. Silicone elastomers are well known in the art and any variety is suitable. As is conventional, silicone rubber may contain a curing agent, such as benzoyl peroxide or di-t-butyl peroxide, as well as conventional filler and other rubber compounding materials.

Preferred elastomers that may be bonded by the adhesive compositions of the present invention include, but are not limited to, silicone elastomers and peroxide cured hydrogenated nitrile butadiene rubbers (HNBR).

The substrate to which the elastomer is to be bonded with the adhesive composition of the present invention may be any substrate known to those of skill in the art. unless otherwise indicated, the term “substrate” referred to herein is other than the bonded cured or uncured elastomer or rubber. For example, the substrate includes, but is not limited to, woven or nonwoven fabrics, or continuous rovings of fiberglass, such as E-glass, fabrics, fibers or rovings of polyamides, polyester, aramids, e.g., Kevlar, a trademark of E. I. du Pont de Nemours Co., (Inc.), of Wilmington, Del., carbon fibers, and stainless steel fibers; ceramics, metals, and the like shaped or in foils or coils. Metals and their alloys to which the elastomers can be bonded include, but are not limited to, steel, stainless steel, lead, aluminum, copper, brass, bronze, Monel metals, nickel, zinc, and the like, including treated metals such as phosphatized steel, galvanized steel, and the like.

The adhesive compositions of the present invention are prepared by conventional means. The block copolymer is typically dissolved in a solvent and then mixed with the crosslinker by conventional means such as milling. The adhesive compositions are applied to the surface(s) of the substrate in a conventional manner such as by roll coating, dipping, spraying, brushing, wiping, screen printing and the like. Once the composition has been applied, the adhesive composition is permitted to dry, thus removing or volatilizing the solvent. Examples of suitable solvents include, but are not limited to, aromatic and halogenated aromatic hydrocarbons such as benzene, toluene, xylene, chlorobenzene, dichlorobenzene, and the like; halogenated aliphatic hydrocarbons such as trichloroethylene, perchloroethylene, propylene dichloride and the like; ketones such as methyl ethyl ketone, methyl isobutyl ketone, and the like; ethers, naphthas, etc., including mixtures of such solvents. The amount of the solvent employed is that which provides a composition suitable for use as an adhesive. This amount will ordinarily be about 50% to about 90% by weight, based upon the total adhesive composition.

Preferably, the drying step may be by air drying or by any method known to those of skill in the art. Generally, the air drying step will be conducted at temperatures of less than about 275° F. (135° C.), and preferably less than 200° F. (93° C.).

After the adhesive has been subjected to drying and the solvent has substantially evaporated, the adhesive coated substrate is bonded to an elastomer at an appropriate temperature for the elastomer for the necessary time and pressure. The elastomer may be contacted with the adhesive surface by any of the methods known in the art. The time and temperature of the cure will depend upon the elastomer used and will not affect the adhesive properties of the adhesive composition of the present invention. For example, the temperature used to cure a silicone elastomer is between about 250° F. (121° C.) to about 400° F. (204° C.). After the process is complete, an article of manufacture may be prepared.

The adhesive composition may be used alone as the sole adhesive between the elastomer and the substrate or may be used in conjunction with other primers and adhesives. It has been discovered that the adhesive of the present invention may be advantageously utilized as a topcoat adhesive over known primer compositions to provide satisfactory adhesion between the elastomer and the substrate. The strength of the bond is enhanced over the use of either the primer or other known adhesives or the adhesive composition of the present invention by itself. The adhesive of the present invention advantageously may be used with such primers and adhesives. The following U.S. patents disclose art relating to some of the many primers useful for pretreatment of substrates: U.S. Pat. Nos. 6,268,422, 6,225,408, 6,132,870, 6,130,289, 6,002,778, 5,972,423, 5,907,015, 5,902,645, 5,728,203, and 5,677,414. Well known primers are commercially available, such as under the Chemlok® brand of Lord Corporation, Cary, N.C.

The following examples are provided for purposes of illustrating the invention, it being understood that the invention is not limited to the examples nor to the specific details therein enumerated. In the examples, amounts are parts by weight, unless otherwise specified.

### EXAMPLES

### Example 1

An adhesive composition was prepared by dispersing bismaleimide in toluene in a Kady® mill and then dissolving poly(dimethylsiloxane)-etherimide copolymer in the toluene/bismaleimide dispersion for about thirty minutes. Other ingredients such as reinforcement fillers were added under stirring. The resulting adhesive composition in parts by weight (pbw) was as follows. The parts of crosslinker per 100 parts by weight of film former (phr) is listed.

TABLE 1
Composition #1

| Components: | pbw | phr |
|---|---|---|
| SSP-085 poly(dimethylsiloxane)-etherimide block | 7.5 | |
| copolymer | | |
| M-20 Bismalemide | 60 | 800 |
| Silane A-174 methacryloxypropyltrimethoxy silane | 1 | |
| Cabosil | 3 | |
| Toluene | 112 | |

### Example 2

An adhesive composition was prepared by dispersing bismaleimide and N, N′-m-phenylene bismaleimide in toluene in a Kady® mill and then dissolving poly(dimethylsiloxane)-etherimide copolymer in the toluene dispersion for about thirty minutes. Other ingredients such as reinforcement fillers were added under stirring. The resulting adhesive composition was as follows:

TABLE 2
Composition #2

| Components: | pbw | phr |
|---|---|---|
| SSP-085 poly(dimethylsiloxane)-etherimide block | 7.5 | |
| copolymer | | |
| M-20 Bismalemide | 30 | 400 |
| N,N′-m-phenylene bismaleimide | 30 | 400 |
| Silane A-174 methacryloxypropyltrimethoxy silane | 1 | |
| Cabosil | 3 | |
| Toluene | 112 | |

### Example 3

The bonding strength of the adhesive was tested as set forth below:

TABLE 3

| | | | Comparative | Comparative |
|---|---|---|---|---|
| | | | Example #1 | Example #2 |
| | Example | Example | (Thixon ® | (Chemlock ® |
| | #1 | #2 | 304) | 602) |
| Test #1a | 58.4 | 76.4 | 49.5 | 38.4 |
| Conical Bond | | | | |
| Strength | | | | |
| (6061 aluminum | | | | |
| conicals) | | | | |
| Test #1b | 100 | 100 | 0 | 0 |
| Visual % rubber | | | | |
| Test #2a | 36.2 | 35.4 | 35.1 | 31.5 |
| Conical Bond | | | | |
| Strength | | | | |
| (6061 aluminum | | | | |
| conicals) | | | | |
| Test #2b | 100 | 95 | 0 | 0 |
| Visual % Rubber | | | | |

Bonds are evaluated based on strength and visual appearance. Higher bond strength is desirable and torn rubber at the bond surface is desirable. When the failure occurs in the rubber, the results are interpreted as indicating that the rubber rather than the bond is the limiting factor. It has also been found that the bonds generally have better environmental resistance when the failure is in the rubber section. Test 1a and 1b were made with a silicone rubber compound which has been shown to be difficult to bond. These tests show that the bonds obtained with the adhesives from example 1 and 2 provide higher bond strength and better visual appearance (100% failure in the rubber section) than bonds made with commercially available adhesive controls. Test 2a and 2b were made with a different silicone compound which has also been known to be difficult to bond. These tests show that the bonds obtained with the adhesives from example 1 and 2 have similar bond strength to the commercial controls, but the failure is now in the rubber section (95 to 100% rubber) rather than between the metal and the adhesive or between the adhesive and the rubber (0% rubber).

### Example 4

Compositions #1 and #2 were used to bond two different peroxide cured HNBR rubber compounds. They were used to bond KM001, a very soft and highly plasticized HNBR and KM003, a very stiff HNBR containing Nippon Zeon ZSC-2295, a zinc oxide and methyl methacrylate modified HNBR. KM001 exhibited 130-146 lbs. pull for method C conical specimens while KM003 had pull values of 700-800 lbs. All specimens bonded with the adhesive composition of the present invention broke in the rubber section with significantly higher pull values than has been seen with commercially available adhesives. For example, KM001bonded with either the commercially available Chemlok® or Thixon® adhesive gives break values of only around 100 lbs.

TABLE 4

| | KM001 | | KM003 | | |
|---|---|---|---|---|---|
| | Pull (Lbs.) | | Pull (Lbs.) | | |
| | (20 min. | | (16 min. | | |
| | cure time | Bond | cure time | | |
| Adhesive | at 325° F. | App. | at 325° F. | Bond App. | |
| Comparative #3 | 98 | 100 R | 541 | 95-100 | R, |
| Chemlok ® 8003/ | | | | | CM |
| ED7787-89 | | | | | |
| Comparative #4 | 99 | 0-100 R* | 389 | 94-100 | R, |
| Thixon ® P-6-3/ | | | | | CP |
| Chemlok ® 259 | | | | | |
| Comparative #5 | 104 | 0-100 R* | 390 | 100 | R |
| Chemlok ® 207/ | | | | | |
| Chemlok ® 254 | | | | | |
| Example #2 | 146 | 100 R | 782 | 100 | R |

*= porosity in the rubber section
CM = (Cement-Metal) means bare metal showing; adhesive lifted off with elastomer
CP = (Cement-Primer) in those examples where a primer-topcoat is used, means the top coat separated with rubber leaving primer adhered to metal (primer still seen sticking to metal)
R = (Rubber) means rubber failure in the body of the rubber.

While the reference has been described in detail with reference to specific embodiments thereof, it will be apparent to one skilled in the art that various changes and modifications can be made without departing from the spirit and scope thereof.

We claim:

1. An adhesive composition for bonding an elastomer to a substrate comprising a solvent, a crosslinker and a film former, wherein the crosslinker comprises at least one organic compound that is reactive with said elastomer to chemically couple the elastomer to the adhesive, and wherein the film former is a block copolymer with a polysilicone segment and a hard segment.

2. The adhesive composition according to claim 1, wherein the film former is selected from the group consisting of polyimide-polysiloxane block copolymers, silicone-polyetherimide block copolymers, poly(arylimide)-poly(dimethylsiloxane) block copolymers, and aromatic polyamide-disiloxane multiblock copolymers.

3. The adhesive composition according to claim 2, wherein the film former is a poly(dimethylsiloxane)-etherimide copolymer.

4. The adhesive composition according to claim 1, wherein the crosslinker is a compound selected from the group consisting of triallyl cyanurate, trimetharyl isocyanurate, triallyl isocyanurate, triacrylformal, triallyl trimellitate, bismaleimide, polymaleimide, N,N′-m-phenylenebismaleimide, diallyl phthalate, tetrallyl terephthalamide, tris(diallylamine)-S-triazine, triallyl phosphite, and N,N-diallylacrylamide, zinc diacrylate, zinc triacrylate and zinc dimethacrylate and a combination thereof.

5. The adhesive composition according to claim 1, wherein the crosslinker is present in an amount from about 100 parts by weight to about 2000 parts by weight based on 100 parts by weight of the film former.

6. The adhesive composition according to claim 1, wherein the film former is present in an amount from about 2 parts by weight to about 20 parts by weight based on the weight of 100 parts of said solvent.

7. An adhesive composition comprising:
a) a crosslinker selected from the group consisting of bismaleimide, polymaleimide, N, N′-m-phenylene bismaleimide, and a combination thereof, and
b) a poly(dimethylsiloxane)-etherimide copolymer.

8. A bonded composite comprising a peroxide-cured elastomer and a substrate other than said elastomer, said elastomer and substrate bonded by the adhesive composition according to claim 1, wherein said elastomer is selected from the group consisting of silicone rubber, nitrile rubber, ethylene/propylene copolymer rubber (EPM); ethylene/propylene/diene terpolymer rubber (EPDM), and hydrogenated nitrile butadiene rubber (HNBR).

9. The adhesive composition according to claim 1, wherein the crosslinker is present in an amount from about 500 parts by weight to about 900 parts by weight based on 100 weight parts of said film former

10. A method of bonding an elastomer to a substrate, the method comprising:
a) coating the substrate with an adhesive composition wherein the adhesive composition comprises in admixture, a solvent, a crosslinker reactive with a peroxide and a block copolymer comprising a polysilicone segment and a hard segment,
b) drying the adhesive composition coating,
c) applying the elastomer to the adhesive composition coating, and
d) curing the elastomer in the presence of a peroxide and heat, and
e) chemically coupling said elastomer to said adhesive.

11. The method according to claim 10, wherein the crosslinker is selected from the group consisting of bismaleimide, polymaleimide, N, N′-m-phenylene bismaleimide, and a combination thereof.

12. The method according to claim 10, further comprising the step of coating the substrate with a primer composition prior to applying the adhesive composition.

13. The method according to claim 10, wherein the substrate is metal.

14. The method according to claim 10, wherein the elastomer is selected from the group consisting of a silicone elastomer, a nitrile elastomer, ethylene/propylene copolymer rubber (EPM); ethylene/propylene/diene terpolymer rubber (EPDM), and hydrogenated nitrile butadiene rubber (HNBR).

15. The method according to claim 10, wherein the block copolymer is selected from the group consisting of polyimide-polysiloxane block copolymers, silicone-polyetherimide block copolymers, poly(arylimide)-poly(dimethylsiloxane) block copolymers, and aromatic polyamide-disiloxane multiblock copolymers.

16. The adhesive composition according to claim 15, wherein the film former is a poly(dimethylsiloxane)-etherimide copolymer.

17. An article of manufacture comprising:
a) a metal substrate,
b) a cured adhesive composition comprising at least one peroxide-reactive organic crosslinker compound and a block copolymer with a polysilicone segment and a hard segment, and
c) a cured elastomer chemically coupled to said adhesive
said adhesive forming a bonded interlayer between a) and c).

18. The article of manufacture according to claim 17, wherein the block copolymer is selected from the group consisting of polyimide-polysiloxane block copolymers, silicone-polyetherimide block copolymers, poly(arylimide)-poly(dimethylsiloxane) block copolymers, and aromatic polyamide-disiloxane multiblock copolymers.

19. The article of manufacture according to claim 17, wherein the organic compound is selected from the group consisting of bismaleimide, polymaleimide, N, N′-m-phenylene bismaleimide, and a combination thereof.

20. The article of manufacture according to claim 17, wherein the elastomer is a silicone elastomer or a peroxide cured hydrogenated nitrile butadiene rubber (HNBR).

21. An adhesive essentially absent a nitroso compound, and comprising from 50% to 90% by weight of an organic solvent, a film former, and from about 100 to about 2000 parts by weight per 100 parts of said film former of a crosslinker, said film former is selected from the group consisting of polyimide-polysiloxane block copolymers, silicone-polyetherimide block copolymers, poly(arylimide)-poly(dimethylsiloxane) block copolymers, and aromatic polyamide-disiloxane multiblock copolymers.
